(19) United States
(12) Patent Application Publication
(10) Pub. No.: US 2007/0224382 A1
(43) Pub. Date: Sep. 27, 2007

(54) TWO-SHOT MOLDED DOORS WITHOUT PARTING LINES

(75) Inventors: Glenn A. Cowelchuk, Chesterfield Township, MI (US); David J. Dooley, Troy, MI (US)

Correspondence Address: ARTZ & ARTZ, P.C., 28333 TELEGRAPH ROAD, SUITE 250, SOUTHFIELD, MI, 48034, US

(73) Assignee: LEAR CORPORATION, Southfield, MI (US)

(21) Appl. No.: 11/306,034

(22) Filed: Dec. 14, 2005

(51) Int. Cl. G09F 3/00; B28B 5/00; B32B 9/04; B28B 7/22

(52) U.S. Cl. 428/43; 264/250; 264/255; 428/411.1

(57) ABSTRACT

A two-shot injection molding process and molded part. The two-shot skin material is molded in a non-final condition and wrapped over the substrate in a post molding operation to create a seamless part. The flap material which is molded out of its final position is held in place by gluing, mechanical interlocking, crimping, or the like.

### TECHNICAL FIELD

The present invention relates to the elimination of visible parting lines on plastic molded articles.

### BACKGROUND OF THE INVENTION

Injected molded products are in common use today, particularly in the automotive industry. Many of these plastic products are made by a plastic injection molding process. In these processes, cavities formed in molds are filled with molten plastic material which, when cooled and ejected from the mold, forms the completed product.

Due to the complex structure and configuration of many of the molded plastic products, the products are often injection molded with parting lines formed by the molding process visible on the exposed surfaces. These parting lines can be apparent, for example, on molded plastic components for door panels for the automotive industry.

Mold parting lines on the exposed surfaces of molded products and components are typically not aesthetically pleasing.

### SUMMARY OF THE INVENTION

It is an object of the present invention to provide an improved plastic molded product without mold parting lines on its exposed viewing surfaces. It is also an object of the present invention to provide an improved plastic injection molding process which produces a molded product without parting lines on any of the viewing surfaces.

The above objects are met by the present invention which provides an improved plastic injection molding process and an improved molded plastic product or component which eliminates parting lines on the exposed or viewing surfaces. The molded part is produced in a two-shot process utilizing a rotational mold. A first portion of the molded product is produced in a first cavity on the rotational mold, and the second portion or layer of the product, namely the outer skin layer, is produced in a second cavity on the rotational mold. Preferably, the first portion of the product is formed of a hard plastic material, while the second portion is formed of a softer thermoplastic elastomer material.

The second portion of the product is formed in the mold with a part thereof that is not attached to the first portion. After the molded part is removed from the mold, the non-attached part is folded over onto the first portion in a post-molding operation. The portion which is folded over is then glued or otherwise securely affixed to the first portion.

These and other features, benefits and advantages of the present invention will become apparent from the following description when viewed in accordance with the accompanying drawings and appended claims.

### BRIEF DESCRIPTION OF THE DRAWINGS

FIG. 1 is a perspective view of a plastic molded product made in accordance with the present invention.

FIG. 2 is a schematic illustration depicting a processing step in accordance with the present invention.

FIG. 3 illustrates another processing step in accordance with the present invention.

FIG. 4 is a cross-sectional view of the molded two-shot product produced in accordance with the present invention.

FIGS. 5 and 6 illustrate alternative embodiments of the final molded product in accordance with alternative embodiments of the present invention.

### DESCRIPTION OF THE PREFERRED EMBODIMENT(S)

Plastic molded products or components, particularly those used in the automotive industry, typically require having an outer layer or viewing surface which is aesthetically pleasing and does not have any blemishes or parting lines. Such surfaces are also called “Class A” surfaces. The opposite or non-visible side of the molded products or components is typically called the “Class B” surface. The molded products often have a base or substrate portion and an outer or skin portion made from a different material. The outer or visible layer often can be a softer material, such as a thermoplastic elastomer material, and can be molded with the desired texture or other ornamentation.

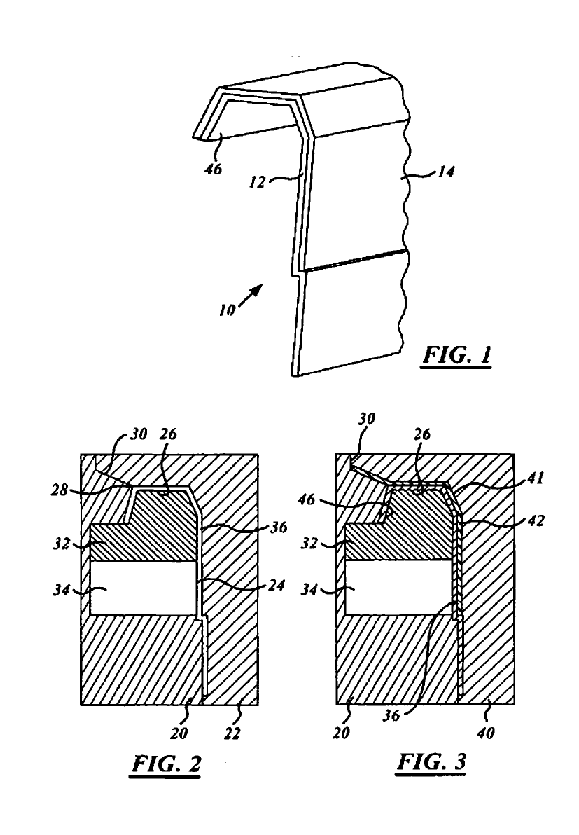

A two-shot final molded product is shown in FIG. 1 and indicated generally by the reference numeral 10. The molded product 10 includes a base or backing substrate portion 12 covered in part by a second molded layer 14 over a portion of the surface. Typically, the base substrate portion 12 is made from a hard plastic material, while the second or outer layer portion 14 is made from a softer material, such as a thermoplastic elastomer material. The second layer can be a skin 14 which is molded onto the backing or first layer 12 to form the completed product 10.

In accordance with the present invention, the molded product 10 is made in a two-shot molding process, preferably by use of a rotational mold. In a rotational mold, there is typically one core portion of a mold tool and a pair of cavity portions. In the first step of the rotational molding process, the core member is mated with the first cavity member and a portion of the molded product is produced. Thereafter, the core portion or the cavity portion of the rotational molding machine is rotated lining the second cavity portion with the core portion. The first molded portion remains in the core portion and then when the second cavity portion is mated with the core portion, the second layer of material is molded over or onto the first molded portion. This creates a two-shot molded product.

These steps are illustrated in FIGS. 2 and 3. In FIG. 2, the core portion 20 is shown mated with the first cavity portion member 22. A cavity 24 is machined or formed between the core and cavity members. In the cavity shown, the molded product is the upper component for a vehicle door member and includes an upper U-shaped portion 26, the corner 28 of which is on the parting line 30 of the mold tool. Due to the configuration of the molded part, a lifter member 32 is utilized with the mold tool. When the two-shot part is completely molded, the lifter member 32 is moved into the adjacent open area 34 in order to allow the final molded part to be removed from the mold.

In accordance with the present invention, after the mold cavity 24 is filled with the plastic material forming the molded part 36 in the shape shown, the first cavity member 22 is separated from the core member 20. The rotation of the rotating platen on the rotational mold aligns the core member 20 with a second cavity member 40. This is shown in FIG. 3. When the two mold portions 20 and 40 are mated together, a second cavity 41 is formed. The cavity 41 is then filled with a second plastic material by an injection molding process. Preferably, as indicated above, the first molded portion 36 is formed of a hard plastic material, while the second molded portion 42 is made of a softer thermoplastic elastomer material forming a skin on the substrate portion 36.

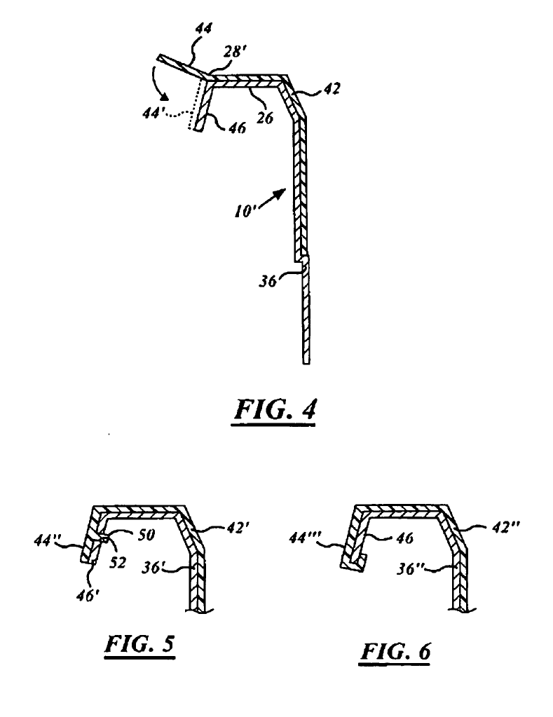

The molded product as completed by the rotational molding process is shown in FIG. 4. When the lifter member 32 is moved out of its position as shown in FIGS. 2 and 3, thus allowing the molded product to be ejected and removed from the mold, the resulting product is shown schematically in FIG. 4 and referred to generally by the reference numeral 10′. The product 10′ has a hard plastic molded substrate 36 covered for the most part by an outer skin portion 42 which is on the visible or viewing surface of the molded part. As shown in FIG. 4, a flap portion 44 of the second molded plastic portion is molded in a non-final position. Thereafter, the flap portion 44 is formed in a post molding operation into the position 44′ as shown in FIG. 4 completing the final product 10 (as shown in FIG. 1). With the present invention, the parting line at 28 in the mold shown in FIG. 2 and 28′ in the molded product shown in FIG. 4 does not form an unacceptable unaesthetic line or marking on the final product.

In order to form the final product 10 from the molded product 10′ when it is removed from the mold, flap member 44 is bent over or formed into the position 44′ by any conventional post-molding operation. The flap portion 44 is securely affixed to the corresponding flange portion 46 of the first molded portion 36. Flap portion 44 can be secured to the flange portion 46 in any conventional manner, such as by crimping, gluing, plastic welding or the like. The portions 44 and 46 can also be mechanically interlocked together with a tab 50 or the like which is positioned through an opening 52 in the flap portion 46′ as shown in FIG. 5. In addition, flap portion 44 can be made of an extended length (see 44′″ in FIG. 6) and thus be formed around the end of the flap member 46. This is shown in FIG. 6.

With the present invention, the presence of a parting line on the final molded product is eliminated. The two-shot skin material is molded in a flat condition and is then wrapped over the underlying substrate in a post molding operation in order to create a seamless looking part. The skin member is molded out of its final position. A fixture can be provided adjacent the rotational molding machine in order to bend or form the flap member into its final position. If necessary, an oven or other heating mechanism can be used to make the flap more pliable and easier to fold into its final position.

While particular embodiments of the invention have been shown and described, numerous variations and alternative embodiments will occur to those skilled in the art. Accordingly, it is intended that the invention be limited only in terms of the appended claims.

What is claimed is:

1. A two-shot molded plastic product comprising:
a first injection molded plastic substrate portion and a second skin portion, said second skin portion being injection molded onto at least a portion of said first substrate portion;
a portion of said second skin portion being molded in a non-final position;
said second skin portion being formed into its final position on said first substrate portion in a post-molding process to form said final molded product.

2. The two-shot molded plastic product as described in claim 1 wherein said first substrate portion is a hard plastic material and said second skin portion is a softer thermoplastic elastomer material.

3. The two-shot molded plastic product as described in claim 1 wherein said molded plastic product is made by a rotational molding process.

4. The two-shot molded plastic product as described in claim 1 wherein said portion of said second skin portion which is in a non-final position is secured to said first substrate portion by one of the mechanisms in the group comprising: gluing, crimping, mechanical interlocking and welding.

5. A method for forming a two-shot molded plastic product forming a first injection molded substrate portion in a rotational mold;
forming in said rotational mold a second skin portion on at least a portion of said first substrate portion, an end portion of said second skin portion being formed in a non-final position;
attaching said end portion in a post-molding operation onto said first substrate portion.

6. The method for forming a two-shot molded plastic product as described in claim 5 wherein said end portion is a flap member and is attached by a method in the group comprising: gluing, crimping, mechanical interlocking and welding.

7. The method for forming a two-shot molded plastic product as described in claim 5 wherein said product is an upper component for a door member for a vehicle.
